(19) United States
(12) Patent Application Publication
(10) Pub. No.: US 2005/0210013 A1
(43) Pub. Date: Sep. 22, 2005

(54) Database system and method for managing a database

(76) Inventors: Horst Werner, Rettighelm (DE); Joerg Beringer, Frankfurt (DE); Dennis B. Moore, Hillsborough, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/048,700

(22) Filed: Feb. 3, 2005

(30) Foreign Application Priority Data
Feb. 3, 2004 (EP) 04075326.1

(51) Int. Cl. G06F 17/30

(52) U.S. Cl. 707/3

(57) ABSTRACT

A database management system and method manages a database storing a plurality of entities related to each other by a plurality of relations. A user interface interfaces with the database in a situation. A context modeler models a context representation according to the situation using a semantic net. The semantic net includes a subset of entities that are identified by the context modeler as being relevant to the situation. When the context representation is applied to the database, the database is adapted to operate according to the situation.

This application is based upon and claims the benefit of priority from prior patent application EP 04075326.1, filed Feb. 3, 2004, the entire contents of which are expressly incorporated herein by reference.

### BACKGROUND

I. Technical Field

The present invention relates to a database management system and a method of managing a database.

II. Background Information

Applications, such as business applications, allow the user to work in different contexts. Such applications adapt the information that is displayed and the actions or objects which the user may select according to a respective context. However, the context is not explicitly modeled. Instead, it is implicitly given by the various screens of an application's user interface. Limited context information is stored when the user switches to another screen. While some applications use lists of recently or frequently used objects, the relationship of these objects with respect to the user's activities is unknown to the application.

Therefore, conventional applications typically provide context information that is poor and unavailable for generic algorithms. Instead, the context sensitivity must be hard coded for each screen. The present invention addresses problems encountered with conventional applications and improves the context representation in the application.

### SUMMARY

Consistent with the present invention, a database management system is provided for managing a database. The system comprises a database storing a plurality of entities related to each other by a plurality of relations; a user interface for interfacing with the database in a situation; and a context modeler for modeling a context representation, wherein the context modeler models the context representation according to the situation using a semantic net that includes a subset of entities identified by the context modeler as being relevant to the situation, and wherein the database is adapted to operate according to the situation when the context representation is applied to the database.

Also consistent with the present invention, a method is provided of managing a database storing a plurality of entities related to each other by a plurality of relations. The method comprises providing a user interface for interfacing with a database in a situation; modeling a context representation in accordance with the situation, wherein a subset of the plurality of entities that are relevant to the situation are identified; forming a semantic net that includes the subset of plurality of entities and relationships between the entities included in the subset of entities; modeling the context representation using the semantic net; and applying the context representation to the database so that the database is adapted to operate according to the situation.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 shows an architecture incorporating an embodiment consistent with the present invention;

FIG. 2 shows aspects of the architecture shown in FIG. 1 in further detail; and

FIGS. 3A and 3B show a flow diagram incorporating methods of managing a database in accordance with an embodiment consistent with the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

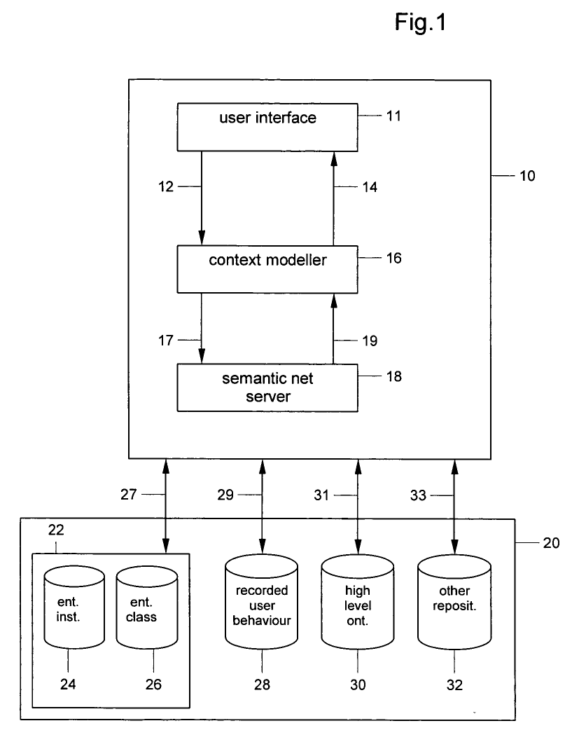

FIG. 1 shows an architecture incorporating an embodiment consistent with the present invention. System 10 implements the following process and, in particular, the data flow and data processing steps initiated by the database management system. System 10 includes a user interface 11 that is a graphic user interface (GUI), with which a user interacts. Typically, at any one time, a user may be involved in an action or a process 12, or both.

System 10 also includes a context modeler 16 and a semantic net server 18. Action or process 12 is input to context modeler 16. Data may be exchanged via connections 12 and 14 between user interface 11 and context modeler 16. Similarly, data may be exchanged via connections 17 and 19 between context modeler 16 and semantic net server 18.

Context modeler 16 determines which entities 61 form the context representation. The context representation typically includes at least one component. Context modeler 16, in association with semantic net server 18, further stores references to entities 61, which may be recently used entities 61, by means of a semantic net representation. The context of an entity or a situation as defined by the process or action is a collection of facts and entities 61 that are of special importance for the entity or situation and that usually have a direct or indirect relationship to the entity or situation. Within a business application, such as a database, a context may be defined for a variety of entities 61 or a situation including, but not limited to a user, a session, or a business entity. For a user, the context may include entities 61 including his role, projects, and personal preferences. For a session, the context may include entities 61 including a user, last actions, and manipulated business entities 61. For a business object, the context may include entities 61, which include past projects or orders for a customer. As described hereinafter, a business object is an entity stored in a database. A business application 20 may typically include a database 22 in which business entities 61 are stored.

A combination of different contexts, for example a user context and a session context, may be combined to form a current context within a session. The elements (“elements” are referred to as being entities 61 belonging to a group of entities 61) of such a composed context may have different temporal validities. The temporal validity may be defined by system 10 and/or by a user. For example, there are long-term elements such as the industry branch of the user's company, the user's role in that company, his current projects, or his activities in the last few days. Similarly, there are short term elements such as, but not limited to, the current transaction, and entities 61 displayed or manipulated in the current session.

Technically, a context may be represented by a number of instances of business entities 61, processes/actions, or situations. A situation may be defined by at least one of a process or an action. As mentioned above, context modeler 16 identifies context elements or entities 61, and entities 61 related to these for the context representation by means of a semantic net representation.

Representations of business entities 61 that are related to each other are stored in database 20. This relation can be explicitly modeled in the database and is called first level relatedness. The relatedness may be implicitly contained by database 20 if there is an intermediate business object to which two other business entities 61 are related. Such a situation refers to second level relatedness. Other chains of relationships between business entities 61 may be found. Depending on the length of such a chain there is a third level relatedness, a forth level relatedness, and so on.

A problem encountered in evaluation of relatedness of second and higher levels is the large amount of data that must be evaluated. If an average entity is (directly) related to 20 other entities 61, there are 400 entities 61 with a second level relatedness, 8,000 third-level-related entities 61, and 160,000 fourth-level-related entities 61. If higher-level relatedness is to be displayed to the user, an intelligent selection of relevant entities 61 is performed. The relevance of entities 61 is context dependent. Context modeler 16 ascertains the relevance of the entities 61 to determine the limited object set to be evaluated.

In a further embodiment consistent with the present invention, the relatedness between two entities 61 may not be available in the database model, but in the mind of the user. In an embodiment, this kind of relatedness is included in a database if an appropriate mechanism is provided independently of the database's entity relationship model. For example, an independent mechanism may be explicitly declared by the user or deduced from his behavior. According to another embodiment, the semantic net containing the plurality of entities 61 corresponding to those entities 61 stored in the database 22 is enriched by an ontology representing general and domain-specific knowledge. Such an ontology allows the evaluation of relatedness between context entities 61 based on superordinate semantic information, for example that a company has employees and that a user is an employee. Thus, the application, in particular with respect to the database 22 may draw conclusions about the current context that would not be possible by evaluating the database contents or structure.

Context modeler 16 identifies the context representation from a semantic net stored in semantic net server 18. Context modeler 16 uses the data model offered by semantic net server 18. In particular, context modeler 16 identifies a subset of the data stored in semantic net server 18 to determine a context representation. Semantic net server 18 may be regarded as an access layer for context modeler 16 providing the data required to context modeler 16. A semantic net is a data structure made up of nodes and relations between those nodes. The nodes represent terms and they are embedded in abstraction hierarchy by means of the special relation type “is a.” A semantic net is the common way of representing ontologies in a computer system.

While it is known to provide a semantic net as an abstraction layer to search and navigate on top of an existing database, it is not known to model context using a semantic net. In contrast, according to an embodiment consistent with the present invention, context is modeled in a business application by storing context-relevant entities 61 and entities 61 related to these by means of a semantic net. Representations of processes and actions may also be integrated in this data structure as well as a general knowledge ontology.

An ontology is an explicit specification of a conceptualization. A conceptualization is an abstract, simplified view of the world it is desired to represent for some purpose. An ontology contains the vocabulary (terms or labels) and the definition of the concepts and their relationships for a given domain. An ontology is a representation that exists independent of any computer models or implementations.

Process or action 12 may include a request to have certain data represented or displayed from database 22, which forms part of an application. The type of application may be a business application or any other appropriate application. In FIG. 1, a business application 20 is shown. The business application includes a database 22 in which business entities 61 are stored. Entity instances are stored in a first storage medium 24. Entity classes are stored in a second storage medium 26. The first and second storage media 24 and 26 represent logical storage media. It is not necessary that first and second storage media 24 and 26 are embodied by physical storage media.

Business application 20 further includes a recorded user behavior storage medium 28 for storing user behavior, a high level ontology storage medium 30 for storing a high level ontology, and other repositories 32 for storing data. Database 22, recorded user behavior storage medium 28, high level ontology storage medium 39, and other repositories 32 may exchange data with user interface 10 via communication links 27, 29, 31 and 33, respectively.

Having initiated a process or action, the user receives an output in the form of a delivery of data 14 from database 22 representing the results of the process or action. The delivery of data 14 is influenced in accordance with the context representation modeled by context modeler 16. In particular, the user's behavior is observed by system 10, in particular in terms of the actions 66 and processes 65 being carried out, and is used by context modeler 16 to model the context representation.

In the example, only one database is shown. Context modeler 16 may be arranged to model a context representation to influence the delivery of data from at least one database. For example, a plurality of databases may influenced by the context representation modeled by context modeler 16.

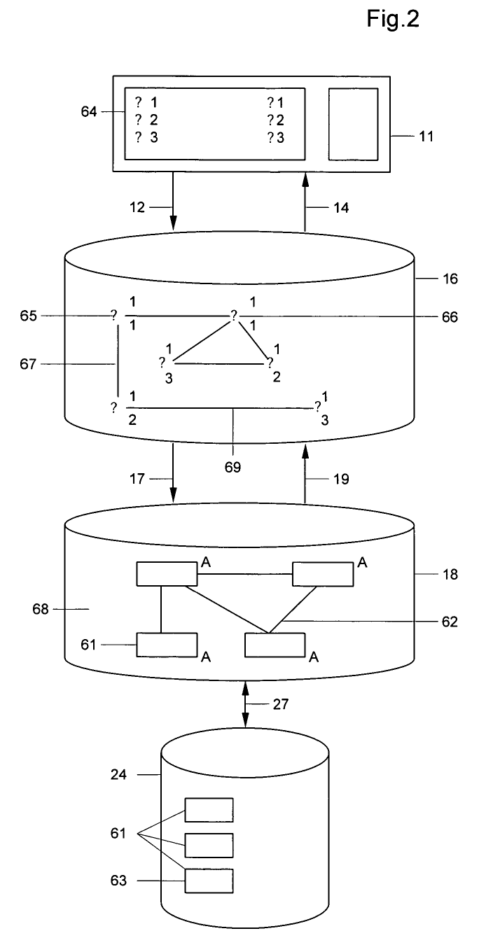

FIG. 2 shows aspects of the architecture shown in FIG. 1 in further detail. In particular, FIG. 2 shows a plurality of entities 61 stored in first storage medium 24. When entities 61 form a group, one entity within that group is referred to as an element 63. Semantic net server 18 stores a semantic net 68 representing the entities 61 and relations 62 between the entities 61. In a particular embodiment, an attribute A is associated with each entity. Attribute A is a value included in the representation of an entity, and may for example, be a number or a word. In this way, it is not necessary to use different tables or structures for different entity types. Instead, it is possible to represent the different entity types in a uniform manner. To ascertain what type an entity is, the type attribute A is evaluated to find out, for example, that a particular entity “is a person” or “is a product.”

Furthermore, with reference to FIG. 2, the user is typically involved with processes and/or actions. The processes and/or actions give rise to a situation. Context modeler 16 observes the behavior of the user in terms of the guided procedures 64 carried out. Representations of processes 65 and actions 66 followed are created. A semantic net 67 of the guided procedures followed including relations 69 between the representations of the processes 65 and actions 66 is formed. It will be understood that the representations of the processes 65 and actions 66 will include at least one of the entities 61 stored in first storage medium 24 and hence, included in the semantic net 68 stored in semantic net server 18. Context modeler 16 identifies the entity or entities 61 associated with the particular processes and actions being followed at a particular moment in time and models a context representation to include the identified entity or entities 61.

In one embodiment, the business application is concerned with staffing a project. A user creates the representation of a new project in a business application.

The project has the following attributes or relations
customer
project goals, defined by key performance indicators and corresponding values
project phases
tasks
persons assigned to these tasks
project status.

The business application includes a template for that type of project containing the following tasks for the first phase:
clarification of customer requirements
high-level feasibility evaluation
technical evaluation
financial analysis
contract preparation.

The semantic net representation appears as follows:
current screen: is assigned to project details,
current user: is assigned to Joe Miller.
Joe Miller
is a user
is responsible for Yancheng power plant
is responsible for <list of past projects>
has role project manager
is part of department power plants
is currently performing action “create project”.
Yancheng power plant
is a project
is located in Yancheng
has customer Yancheng Steel Works
contains clarification of customer requirements
contains technical evaluation
contains financial analysis
contains contract preparation
has status new.
project manager
is a role
is responsible for a project
has access to budget planning
can perform “create project”
can perform “task assignment”.
power plants
is a department
contains power plants engineering team
contains power plants accounting team.
create project
is an action
refers to project
is part of project management tool
is predecessor of assigning tasks.
assign tasks
is an action
is part of project management tool
refers to task
refers to person.
Yancheng steel works
is a customer
is located in Yancheng
has industry branch steel projection.
Yancheng
is a city
is part of China

The facts and entities 61 listed above are examples of entities 61. Entities 61 define the components of the context representation. The semantic net representation may be built up from various sources, such as databases, predefined patterns or the like. It is known to provide a semantic net on top of the contents of a database of an application for primarily search and navigation purposes.

According to an embodiment, context relevant entities 61 and entities related to these 61 are stored by means of a semantic net. By providing semantic-net-based context representations in an application, the advantage over conventional applications is achieved that the behavior of a user can be taken into account. In contrast to conventional semantic nets provided on top of a database, according to a further embodiment consistent with the present invention, there is a limited number of entities 61 marked as relevant in the current context and that these entities 61 include a seamlessly integrated representation of the current situation, as defined for example, by the screen, user and/or actions, in addition to the database entities 61. It has been found that making a copy of the database takes too long if the context is to be accurately represented in a time dependent manner. Further, it has been found that it is sufficient to provide only the relevant propositions relevant to the user, rather than the whole database, in order to provide current context representation.

Context modeler 16 models the context to provide a context representation relevant to the user. This is achieved by limiting the number of entities 61 offered to the user. In this way a seamless integration of the operation is achieved. The situation defining the context may be defined in a variety of ways. For example, it may be defined by at least one of the following: by observing a user behavior by assessing the activities of other users, by observing process patterns that reoccur, and by observing business processes. If a context representation is to be determined taking into account a business process, this may be done provided the business process is not hard coded. By modeling a context representation as described above, the context representation is guided to reflect a current context. By soft coding the context representation it may be supported by the business application yet is readily changed.

Entities 61 may be added to the context representation when they are put into an input field or when they are viewed or touched in any other way. The context representation as modeled by context modeler 16 exists independently from a particular screen or other user interface elements. However, the used screen may contribute entities 61 to the context. Entities 61 may be removed from the context when they have not been used or touched for a predetermined time. The predetermined time may vary and may be set by a user. Alternatively, the system may determine the time interval.

An algorithm to identify context relevant items on the basis of the data structure outlined above, determines the set of all entities 61 related to any of the entities 61 in the context and then, in successive steps, identifies entities 61 related to any of the entities 61 in that set, which therefore are indirectly related to entities 61 in the context. Since the number of entities 61 in the set increases exponentially with each iteration, a numeric value for importance to relation types and entity types is assigned in order to be able to reduce the number of related items which are put into the set. For this purpose only entities 61 with a high importance or which referred to by a relation of high importance are added to the set of indirectly related entities 61. In this way, the entities 61 which may define the context are limited.

As mentioned above, according to an embodiment consistent with the present invention, probable values for given input fields are determined and proposed by the system 100. This is referred to as slot filling. For the purpose of slot filling, the system reduces the set of indirectly related entities 61 to those elements fitting in the given slot/input field by entity type and/or other required attributes and relatedness to the current context. For this the current context as modeled by context modeler 16 is taken into account.

The algorithm to identify relevant entities 61 in a large object set, that is, an algorithm whose function is a context sensitive filter, determines the intersection between the given large object set and the set of indirectly or directly related entities 61.

In another embodiment, database management system manages a database 22. Database 22 stores a plurality of entities 61 related to each other by a plurality of relations 62. The database management system comprises a user interface 11 for interfacing with the database 22 in a situation 64; and a context modeler 16 for modeling a context representation, wherein the context modeler 16 is arranged to model the context representation using a semantic net 67, 68 which includes a subset of the entities which are identified by the context modeler 16 as being relevant to the situation 64, so that when the context representation is applied to the database 22 the behavior of the database 22 is adapted in accordance with the situation 64.

In an embodiment, the situation is defined by a procedure 64 which includes at least one of a process 65 and an action 66 of a user, wherein at least one of the action 66 and the process 65 relate to at least one of the plurality of entities 61. Further, the context representation may include at least one of the plurality of entities 61 related to the at least one process 65 and action 66.

In a further embodiment, the database management system comprises an semantic net server 18 for storing the plurality of entities 61 and the relations 62 between the entities 61 as the semantic net 67. In particular, the subset of the plurality of entities correspond to those entities related to the situation 64. In a preferred embodiment, the semantic net 67, 68 includes the relations 69 of the subset to each other and to the plurality of entities 61 outside the subset. In this way the most relevant entities to the situation are identified by the context modeler 16, so that the quality of data delivered to the user is enriched still further. In a further embodiment, entities 61 may be added to the context representation in accordance with the interaction of the user with the database 22. In this way, the context representation accurately reflects the situation in which the user is active. Similarly, entities 61 may be removed from the context representation in accordance with the interaction of the user with the database 22.

In a further embodiment, the context representation includes components which remains unchanged over a relatively long period of time. Such a component may be the user's company department, his role and current projects.

Similarly, the context representation may include components which remains unchanged over a relatively short period of time. For example, the last user interface screen that have been used. In this way, certain patterns of behavior, such as personal preferences and best practices, are identified by the context modeler. These patterns may then be stored together with other patterns to further enhance the context sensitive user support.

In a further embodiment consistent with the present invention, the invention has application in a generic spreadsheet interface, such as that described in our co-pending application. In particular, in a spreadsheet a view may be defined on a database in terms of a semantic net. The view is completely defined if each of the dependent cells of the spreadsheet has a title and the relation type linking the dependent cell to its respective master cell and the entity type of the entries in the cells. For example, a master cell may be entitled “work package” and a dependent cell may be entitled “is handled by Person”.

Whereas humans are able to understand the meaning of such a view even if the description is incomplete, for example, if the titles are shortened to “work package” and “person” or “work package” and “handled by”, respectively, a conventional database management system would not necessarily understand the meaning of the shortened forms. By applying embodiments consistent with the present invention to a spreadsheet application, this disadvantage is overcome. In particular, using the context modeler based on a semantic net of the present invention, the following advantageous embodiments are provided. In one embodiment, an ambiguous title can be interpreted by means of the context. For example, the context could be analyzed in respect to which relations exist between work packages and persons. The context modeler 16 is then arranged to find the most appropriate relation is “handled by” and auto-complete the view definition correspondingly.

In a further embodiment, if the view is completely defined, there can occur ambiguities concerning the contents due to name identities when data is to be imported from the spread sheet into the database. For example, if the work package is handled by Joe Miller and it transpires that there are three persons in the company called Joe Miller, the context modeler 16 is arranged, in a further embodiment, to select the appropriate person due to his relatedness with respect to the current context. In yet a further embodiment, when data from the database is exported to the spreadsheet application, the context is used to limit the set of the exported entities to those relevant to the current context.

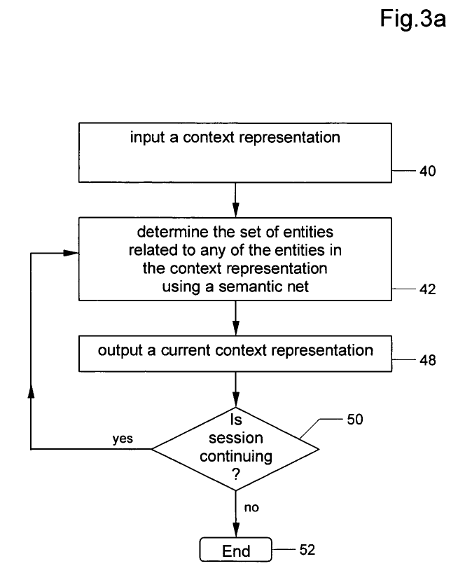

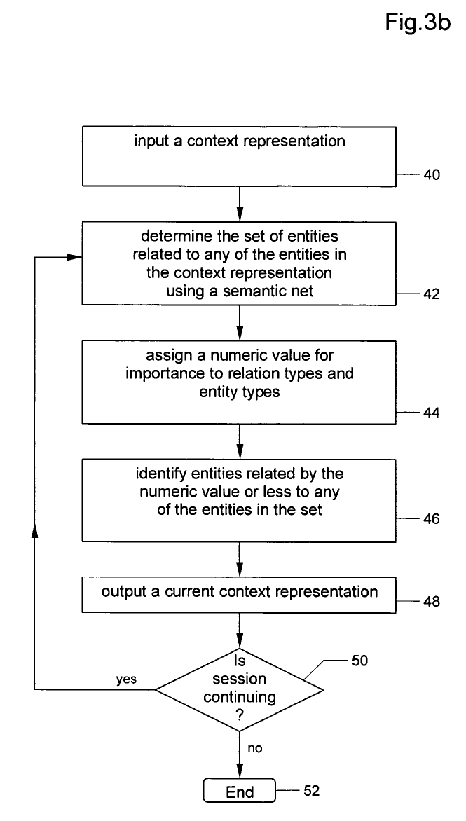

FIGS. 3A and 3B show a flow diagrams incorporating a method of managing a database in accordance with embodiments of the present invention. As can be seen in FIG. 3A, a process 200 is shown which includes the steps of inputting a context representation (step 40) to a context modeler 16. This step may include accessing a context representation stored in context modeler 16. A further step of determining the set of entities 61 related to any of the entities 61 in the context representation using a semantic net, which includes a subset of the entities which are identified by context modeler 16 as being relevant to the situation (step 42), outputting a current context representation (step 48). The current context representation replaces the context representation input or accessed in step 40 and represents an updated context representation. Subsequently, context modeler 16 ascertains whether the session is to continue (step 50). If the session is not continuing the process comes to an end (step 52). If the session is continuing, the process returns to step 42. The method steps described above are carried out by the context modeler 16 in association with the semantic net server which stores the semantic net in which the entity types and relation types are represented.

FIG. 3B depicts an embodiment including the steps shown in FIG. 3A. In addition, the embodiment shown in FIG. 3B includes the additional steps of assigning a numeric value for importance to relation types and entity types (step 44) and identifying entities related by the numeric value or less to any of the entities in the set (step 46). In this way, the context representation is modeled to include only the most relevant entities. The numeric value may be set by a user or by the system.

In another embodiment, a method is provided for managing a data stored in a database, wherein the database stores a plurality of entities 61 related to each other by a plurality of relations 62. The method comprises the steps of providing a user interface 11 for interfacing with the database 22 in a situation 64; modeling a context representation, wherein the modeling step includes the step of identifying a subset of the plurality of entities which are relevant to the situation; forming a semantic net 68 including the subset of entities 65, 66 and the relations 69 between the entities included in the subset of entities; and using the semantic net 67, 68 to model the context representation, applying the context representation to the database 22, so that the behavior of the database 22 is adapted in accordance with the situation 64.

A further embodiment includes the step of defining the situation by a procedure 64 which includes at least one of a process 65 and an action 66 of a user, wherein at least one of the action 66 and the process 65 relate to at least one of the plurality of entities 61. In a further embodiment, the step of including in the context representation at least one of the plurality of entities 61 related to the at least one process 65 and action 66 is included. A yet further embodiment includes the further step of storing the plurality of entities 61 and the relations 62 between the entities 61 in an semantic net server 18 as the semantic net 67, 68. In a further embodiment, the subset of the plurality of entities correspond to those entities related to the situation 64.

A further embodiment includes the further step of including in the semantic net 67, 68 the relations of the subset to each other and to the plurality of entities falling outside the subset. Yet a further embodiment includes the further step of adding entities 61 to the context representation in accordance with the interaction of the user with the database 22. Similarly, the further step of removing entities from the context representation in accordance with the interaction of the user with the database 22 may also be included.

In a further embodiment, the present invention has application to a spreadsheet application. In particular, according to an embodiment consistent with the present invention the user interface 11 is a spreadsheet application in which the situation is defined by a view on the database in terms of a plurality of entries in a plurality of respective cells, wherein each cell has a respective title. A further embodiment includes the step of completing an incomplete situation by identifying an appropriate relation between the respective titles.

A further embodiment includes the step of selecting an appropriate entity for the situation in accordance with the entity's relatedness to a current context. A further step of limiting a set of entities to be exported from the database to the spreadsheet in accordance with a current context may be carried out. In this way, the context modeler improves the situation as defined by the view. In particular, relation types between cells is determined by context modeler 16 if it is not unambiguous, further context modeler 16 can be used to determine the set of entities to be exported to spreadsheet 11 from database 22.

Embodiments of the present invention have application to a user terminal comprising means operable to perform any of the methods described. Embodiments also have application to a program storage device readable by a processing apparatus, said device embodying a program of instructions executable by the processor to perform the steps of any one of the methods described.

The invention as described can be implemented in digital electronic circuitry, or in computer hardware, firmware, software, or in combination thereof. An apparatus according to the present invention can be implemented in a computer program product tangibly embodied in a machine readable storage device for execution by a programmable processor; and method steps of the invention can be performed by a programmable processor executing a program of instructions to perform functions of the invention by operating on input data and generating output. The invention can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Typically, a processor will receive instructions and data from a read-only memory and/or a random access memory. Typically, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example, semiconductor memory devices, such as EEPROM, and flash memory devices; magnetic disks such as internal hard disks and removable disks; magneto-optical disks; and CD-ROM disks. Any of the foregoing can be supplemented by, or incorporated in ASICs (application specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

While certain features and embodiments of the invention have been described, other embodiments of the invention will be apparent to those skilled in the art from consideration of the specification and practice of the embodiments of the invention disclosed herein. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

1. A database management system for managing a database, comprising:
a database storing a plurality of entities related to each other by a plurality of relations;
a user interface for interfacing with the database in a situation; and
a context modeler for modeling a context representation, wherein the context modeler models the context representation according to the situation using a semantic net that includes a subset of entities identified by the context modeler as being relevant to the situation, and wherein the database is adapted to operate according to the situation when the context representation is applied to the database.

2. The database management system according to claim 1, wherein the situation is defined by a procedure that includes at least one of a process and an action of a user, and wherein at least one of the action and the process relate to at least one of the plurality of entities.

3. The database management system according to claim 2, wherein the context representation includes at least one of the plurality of entities related to the at least one process and action.

4. The database management system according to claim 1, further comprising:
a semantic net server for storing the plurality of entities and relations between the entities as the semantic net.

5. The database management system according to claim 1, wherein the subset of the plurality of entities correspond to the entities related to the situation.

6. The database management system according to claim 5, wherein the semantic net includes a relationship of the subset to each other and to the plurality of entities outside of the subset.

7. The database management system according to claim 1, wherein entities are added to the context representation according to an interaction of the user with the database.

8. The database management system according to claim 7, wherein entities are removed from the context representation in accordance with the interaction of the user with the database.

9. The database management system according to claim 8, wherein the context representation includes a component which remains unchanged over a long period of time.

10. The database management system according to claim 1, wherein the context representation includes a component that remains unchanged over a short period of time.

11. The database management system according to claim 1, wherein the semantic net includes the plurality of entities stored in the database and an ontology representing general knowledge to provide an evaluation of relatedness between context entities that is based on superordinate semantic information.

12. The database management system according to claim 1, wherein the semantic net includes references to the plurality of entities stored in the database and an ontology representing domain-specific knowledge to provide an evaluation of relatedness between context entities that is based on superordinate semantic information.

13. The database management system according to claim 1, wherein the user interface is a spreadsheet application in which the situation is defined in terms of a plurality of entries in a plurality of respective cells, wherein each cell has a title.

14. The database management system according to claim 13, wherein the context modeler completes an incomplete view definition by identifying an appropriate relation between the titles.

15. The database management system according to claim 13, wherein the context modeler is arranged to select an appropriate entity for the situation in accordance with a relatedness of an entity to a current context.

16. The database management system according to claim 13, wherein the context modeler limits a set of entities that are exported from the database to the spreadsheet application according to a current context.

17. A method of managing a database storing a plurality of entities related to each other by a plurality of relations, the method comprising:
providing a user interface for interfacing with a database in a situation;
modeling a context representation in accordance with the situation, wherein a subset of the plurality of entities that are relevant to the situation are identified;
forming a semantic net that includes the subset of plurality of entities and relationships between the entities included in the subset of entities;
modeling the context representation using the semantic net; and
applying the context representation to the database so that the database is adapted to operate according to the situation.

18. The method according to claim 17, further comprising:
defining the situation by a procedure that includes at least one of a process and an action of a user, wherein at least one of the action and the process relate to at least one of the plurality of entities.

19. The method according to claim 18, further comprising:
including in the context representation at least one of the plurality of entities related to the at least one process and action.

20. The method according to claim 17, further comprising:
storing the plurality of entities and the relationships between the entities in an semantic net server as the semantic net.

21. The method according to claim 17, wherein the subset of the plurality of entities correspond to the entities related to the situation.

22. The method according to claim 17, further comprising:
including in the semantic net the relationships of the subset to each other and to the plurality of entities outside of the subset.

23. The method according to claim 17, further comprising:
adding entities to the context representation according to the interaction of the user with the database.

24. The method according to claim 17, further comprising:
removing entities from the context representation according to the interaction of the user with the database.

25. The method according to claim 17, further comprising:
including a component in the context representation that remains unchanged over a long period of time.

26. The method according to claim 17, further comprising:
including in the context representation a component that remains unchanged over a short period of time.

27. The method according to claim 17, further comprising:
including in the semantic net the plurality of entities stored in the database and an ontology representing a general knowledge that provides an evaluation of a relatedness between context entities that is based on superordinate semantic information.

28. The method according to claim 17, further comprising:
including in the semantic net the plurality of entities stored in the database and an ontology representing domain-specific knowledge that provides an evaluation of relatedness between context entities that is based on superordinate semantic information.

29. The method according to claim 17, wherein the user interface is a spreadsheet application in which the situation is defined by a view on the database in terms of a plurality of entries in a plurality of respective cells, and wherein each cell has a title.

30. The method according to claim 29, further comprising:
completing an incomplete view definition by identifying an appropriate relation between the titles.

31. The method according to claim 29, further comprising:
selecting an appropriate entity for the situation according to a relatedness of an entity to a current context.

32. The method according to claim 29, further comprising:
limiting a set of entities that are exported from the database to the spreadsheet according to a current context.

33. A program storage device readable by a processing apparatus, the device embodying instructions executable by the processor to perform a method of managing a database storing a plurality of entities related to each other by a plurality of relations, the method comprising:
providing a user interface for interfacing with a database in a situation;
modeling a context representation in accordance with the situation, wherein a subset of the plurality of entities that are relevant to the situation are identified;
forming a semantic net that includes the subset of plurality of entities and relationships between the entities included in the subset of entities;
modeling the context representation using the semantic net; and
applying the context representation to the database so that the database operates according to the situation.
